(19) United States
(12) Patent Application Publication
(10) Pub. No.: US 2020/0410734 A1
(43) Pub. Date: Dec. 31, 2020

(54) SPATIAL REPRODUCTION METHOD AND SPATIAL REPRODUCTION SYSTEM

(71) Applicant: Panasonic Intellectual Property Management Co., Ltd., Osaka (JP)

(72) Inventor: Asuka AOKI, Osaka (JP)

(21) Appl. No.: 16/909,286

(22) Filed: Jun. 23, 2020

(30) Foreign Application Priority Data
Jun. 27, 2019 (JP) 2019-120389

(51) Int. Cl. G06T 13/40; G06T 7/20; G06T 7/70; G06T 15/04

(52) U.S. Cl. CPC G06T 13/40; G06T 7/20; G06T 2207/30196; G06T 15/04; G06T 7/70

(57) ABSTRACT

A spatial reproduction method includes: creating, by a receiving device, a three-dimensional virtual space based on spatial information previously acquired by the receiving device; transmitting motion information indicating a motion of an object to the receiving device in real time by a transmitting device communicably connected to the receiving device; and synthesizing, by the receiving device, an avatar of the object with the three-dimensional virtual space based on the motion information.

### BACKGROUND

### 1. Technical Field

The present disclosure relates to a spatial reproduction method and a spatial reproduction system for reproducing an object and a space around the object in real time.

### 2. Description of the Related Art

Unexamined Japanese Patent Publication No. 2019-12533 discloses an information processing device that provides a free viewpoint image generated on the basis of multiple captured images obtained by capturing images of an imaging area from different directions by multiple cameras. The information processing device includes a determination unit that determines virtual viewpoint information that includes information regarding the position of a virtual viewpoint that is determined on the basis of position information on a display terminal in a facility that includes the imaging area, and a transmitter that transmits a free viewpoint image corresponding to the virtual viewpoint information determined by the determination unit. As a result, an image viewed from a point where the display terminal is located in a virtual space created from the images captured by the multiple cameras is transmitted to the display terminal.

In Unexamined Japanese Patent Publication No. 2019-12533, it is necessary to capture images using many cameras in order to generate a free-viewpoint image. Additionally, it is also necessary to transmit images from many cameras and synchronize the cameras, for example. Moreover, since the area for which a free-viewpoint image can be created is limited to an area imaged by multiple cameras from multiple directions, a wider range of area to be spatially reproduced requires a larger number of the systems such as that described in Unexamined Japanese Patent Publication No. 2019-12533. Accordingly, the amount of image data to be transmitted becomes enormous.

### SUMMARY

The present disclosure provides a spatial reproduction method and a spatial reproduction system that reproduce an object and a space around the object in real time with a smaller communication load than in the conventional technique.

A spatial reproduction method according to an aspect of the present disclosure includes: creating, by a receiving device, a three-dimensional virtual space based on spatial information previously acquired by the receiving device; transmitting motion information indicating a motion of an object to the receiving device in real time by a transmitting device communicably connected to the receiving device; and synthesizing, by the receiving device, an avatar of the object with the three-dimensional virtual space based on the motion information.

According to the spatial reproduction method and the like of the present disclosure, it is possible to reproduce an object and a space around the object in real time with a smaller communication load than in the conventional technique.

### BRIEF DESCRIPTION OF DRAWINGS

FIG. 1 is a block diagram showing a configuration example of a spatial reproduction system according to a first exemplary embodiment;

FIG. 2 is a block diagram showing a configuration example of a transmitting device of FIG. 1;

FIG. 3 is a block diagram showing a configuration example of a server device of FIG. 1;

FIG. 4A is a diagram showing a table of a data configuration example of an environment information table;

FIG. 4B is a diagram showing a table of a data configuration example of a spatial environment correspondence table;

FIG. 4C is a diagram showing a table of a data configuration example of a spatial texture database;

FIG. 4D is a diagram showing a table of a data configuration example of an imaging device information table;

FIG. 4E is a diagram showing a table of a data configuration example of a user model database;

FIG. 4F is a diagram showing a table of a data configuration example of a character model database;

FIG. 4G is a diagram showing a table of a data configuration example of a user setting database;

FIG. 5 is a block diagram showing a configuration example of a receiving device of FIG. 1;

FIG. 6 is a sequence diagram showing an operation of the spatial reproduction system of FIG. 1;

FIG. 7 is a flowchart showing a detailed operation example of first data creation processing of FIG. 6;

FIG. 8 is a flowchart showing a detailed operation example of second data creation processing of FIG. 6;

FIG. 9 is a flowchart showing a detailed operation example of space generation processing of FIG. 6;

FIG. 10 is a flowchart showing a detailed operation example of third data creation processing of FIG. 6;

FIG. 11 is a flowchart showing a detailed operation example of data acquisition processing of FIG. 6;

FIG. 12 is a flowchart showing a detailed operation example of spatial reproduction processing of FIG. 6; and

FIG. 13 is a block diagram showing a configuration example of a spatial reproduction system according to a modification.

### DETAILED DESCRIPTION OF THE EMBODIMENTS

Hereinafter, exemplary embodiments will be described in detail with reference to the drawings as appropriate. Note, however, that descriptions in more detail than necessary may be omitted. For example, a detailed description of an already well-known matter or an overlapping description of substantially identical configurations may be omitted. This is to avoid unnecessary redundancy in the following description and to facilitate understanding of those skilled in the art.

Note that the attached drawings and the following description are provided for those skilled in the art by the inventors for a full understanding of the present disclosure, and are not intended to limit the subject matter as described in the appended claims.

### First Exemplary Embodiment

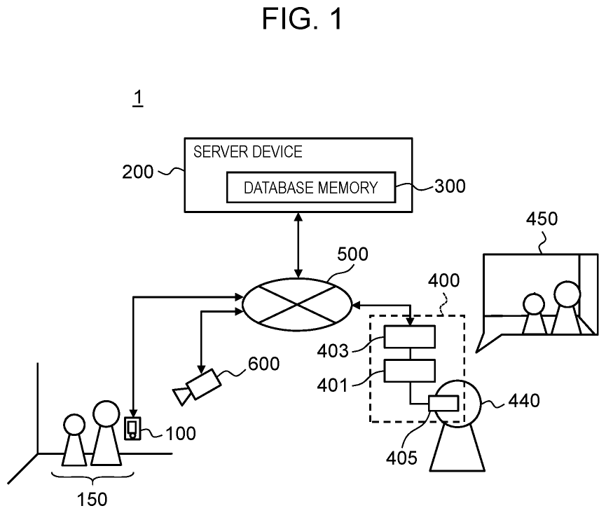

A first exemplary embodiment will be described below with reference to FIGS. 1 to 12.

### [1-1. Configuration]

FIG. 1 is a block diagram showing a configuration example of spatial reproduction system 1 according to the first exemplary embodiment. In FIG. 1, spatial reproduction system 1 captures an image of sender 150 in a wide target area such as a theme park and a space around sender 150 by imaging device 600, and causes receiving device 400 at a position away from sender 150 to display reproduction image 450 reproduced on the basis of the captured image. Multiple imaging devices 600 are installed in the target area, and installation positions are not limited to positions in the target area of sender 150. Instead, imaging devices 600 are installed such that an image of sender 150 is always captured in any one of multiple imaging devices 600. In FIG. 1, only one imaging device 600 whose imaging range includes sender 150 is shown, and other imaging devices 600 are omitted.

In FIG. 1, spatial reproduction system 1 includes transmitting device 100, server device 200, receiving device 400, and imaging device 600. Network 500 is a remote communication network such as the Internet, and transmitting device 100, server device 200, receiving device 400, and imaging device 600 are communicably connected to one another through network 500.

Transmitting device 100 is a terminal device such as a smartphone, and is operated by sender 150 to perform various operations. Server device 200 includes database memory 300, and transmits and receives various information to and from other devices through network 500. Receiving device 400 is a terminal device such as a personal computer (PC), for example, and is operated by receiver 440 to display reproduction image 450 of sender 150 and the space around sender 150 captured by imaging device 600, through display unit 405. Imaging device 600 is a device such as a camera that captures an image of the space in which sender 150 is located.

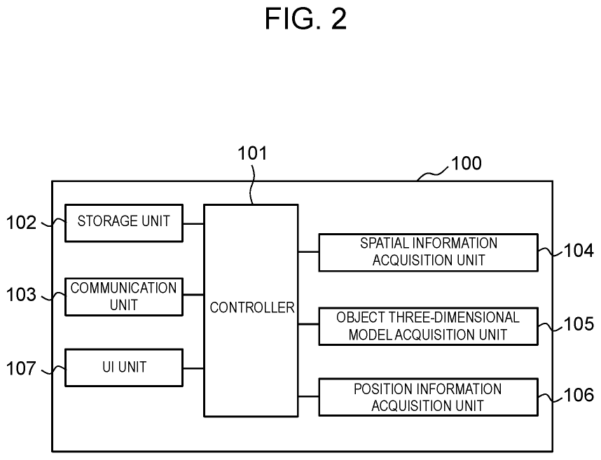

FIG. 2 is a block diagram showing a configuration example of transmitting device 100 of FIG. 1. In FIG. 2, transmitting device 100 includes controller 101, storage unit 102, communication unit 103, spatial information acquisition unit 104, object three-dimensional model acquisition unit 105, position information acquisition unit 106, and user interface unit (UI unit) 107.

In FIG. 2, controller 101 executes a program stored in storage unit 102 or acquired through communication unit 103 to control an operation of each unit of transmitting device 100. Storage unit 102 is a storage device such as a memory, and stores programs executed by controller 101, data from spatial information acquisition unit 104 and object three-dimensional model acquisition unit 105, and the like.

Communication unit 103 communicates with network 500 according to a protocol such as PPP or TCP/IP, and transmits and receives various data including image data and text data to and from other devices. Spatial information acquisition unit 104 acquires three-dimensional (3D) data and texture data of the space including sender 150. Object three-dimensional model acquisition unit 105 acquires a three-dimensional model of sender 150. Position information acquisition unit 106 specifies position information (latitude and longitude) of sender 150 using a system such as a global positioning system (GPS). UI unit 107 is a user interface (UI) such as a touch panel display, for example, and displays various information to sender 150 and accepts input from sender 150.

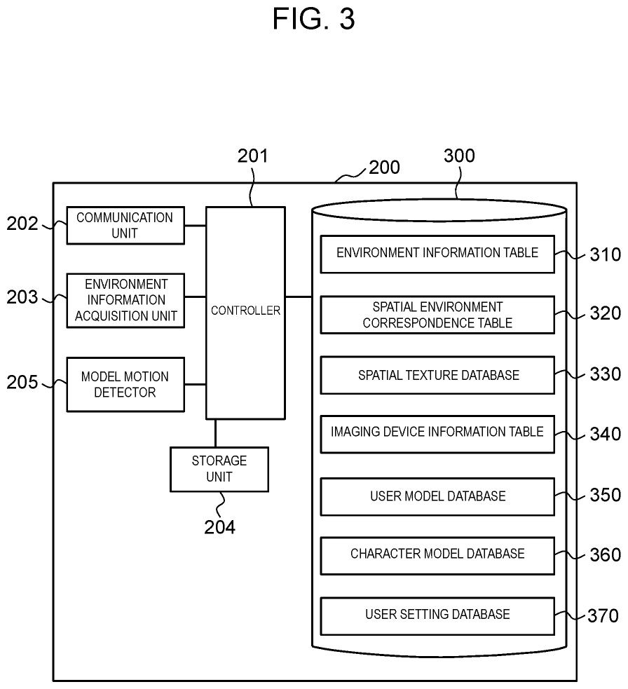

FIG. 3 is a block diagram showing a configuration example of server device 200 of FIG. 1. Server device 200 includes controller 201, communication unit 202, environment information acquisition unit 203, storage unit 204, model motion detector 205, and database memory 300.

In FIG. 3, controller 201 controls an operation of each unit of server device 200 by executing a program stored in storage unit 204, for example. Similar to communication unit 103, communication unit 202 communicates with network 500. Environment information acquisition unit 203 acquires environment information (details will be described later) including weather or time, for example.

Model motion detector 205 detects the motion of sender 150 on the basis of a captured image or the like from imaging device 600. Model motion detector 205 detects skeletal information of sender 150 from a captured image from imaging device 600. Here, the skeletal information is data that represents the appearance of the human body, and, using cylinders to represent main parts of the human body such as the thigh, upper arm, and chest, the skeletal information includes values expressed by the position and angle of the axes of the cylinders.

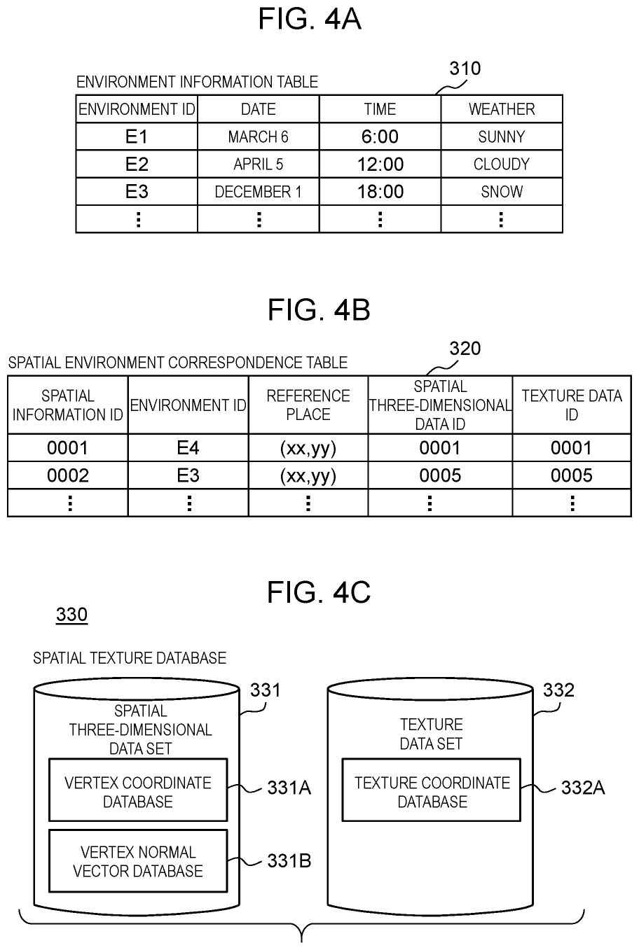

FIGS. 4A to 4G are diagrams showing tables of data configuration examples of various databases included in database memory 300 of FIG. 1. FIG. 4A shows environment information table 310. Environment information table 310 stores multiple pieces of environment information in association with environment IDs. Environment information includes date, time, and weather, and represents an environment that changes depending on the season, time zone, weather, and the like.

FIG. 4B shows spatial environment correspondence table 320. Spatial environment correspondence table 320 stores an environment information set associating a reference place with an environment ID, spatial three-dimensional data, and texture data in association with a spatial information ID. This association indicates a correspondence relationship of what kind of spatial three-dimensional data and texture data a space has when the environment (date, time, and weather) of a certain reference place matches certain environment information.

FIG. 4C shows spatial texture database 330. Spatial texture database 330 includes spatial three-dimensional data set 331 that stores multiple pieces of spatial three-dimensional data, and texture data set 332 that includes multiple pieces of texture data corresponding to any one of the spatial three-dimensional data. Spatial three-dimensional data set 331 includes information necessary to generate a spatial three-dimensional model, such as vertex coordinate database 331A that stores the vertex coordinates of polygons and vertex normal vector database 331B that indicates the normal vector of each vertex. Additionally, texture data set 332 includes texture coordinate database 332A. Note that spatial three-dimensional data and texture data may have a one-to-one relationship, or multiple pieces of texture data may exist for one spatial three-dimensional data.

FIG. 4D shows imaging device information table 340. In imaging device information table 340, a camera ID indicating each of the multiple imaging devices 600, an imaging range in which each imaging device 600 can image, and a captured image-storage address of imaging device 600 are stored in association with one another. The captured image-storage address is an address in storage unit 204 of server device 200, for example, and indicates where to store an image captured by imaging device 600. By referring to imaging device information table 340, server device 200 can determine which of multiple imaging devices 600 is capturing an image of sender 150 from the position information of sender 150.

FIG. 4E shows user model database 350. User model database 350 stores three-dimensional model data and texture data of sender 150 corresponding to a user ID. FIG. 4F shows character model database 360. Character model database 360 stores three-dimensional model data and texture data of a character corresponding to a character ID. FIG. 4G shows user setting database 370. In user setting database 370, a user name of each sender 150 and various setting values are stored in association with a user ID. For example, setting values include a setting value (display target) of whether or not to display an avatar of sender 150 in reproduction image 450, a setting value (avatar) of how to display sender 150 in reproduction image 450, and the like. A display target setting value also includes a setting value for displaying an avatar only to specific receiver 440 having a user ID that matches a friend ID value.

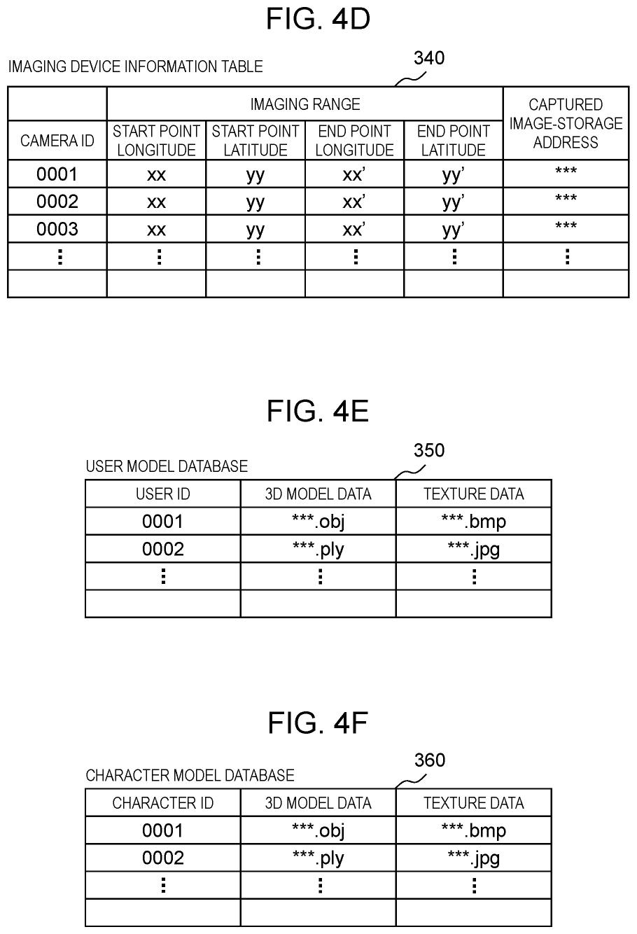

FIG. 5 is a block diagram showing a configuration example of receiving device 400 of FIG. 1. In FIG. 5, receiving device 400 includes controller 401, storage unit 402, communication unit 403, operation unit 404, display unit 405, virtual space generator 406, and real-time spatial reproduction unit 407.

In FIG. 5, controller 401 controls an operation of each unit of receiving device 400 by executing a program stored in storage unit 402, for example. Storage unit 402 is a storage device such as a memory, for example, and stores a program executed by controller 401, spatial three-dimensional data and texture data received from server device 200 through communication unit 403, and the like. Similar to communication unit 103, communication unit 403 communicates with other devices through network 500.

Operation unit 404 is a mouse, a keyboard, a touch panel, a remote controller, and the like, for example, and accepts various inputs from the user. Display unit 405 is a display device such as a head-mounted display, a projector, a liquid crystal display (LCD), a light-emitting diode (LED) display, or the like, and displays various user interfaces in addition to reproduction image 450. Operation unit 404 and display unit 405 may be an integrated unit such as a touch panel display.

Virtual space generator 406 creates a virtual three-dimensional space that reproduces the space where sender 150 is, using spatial three-dimensional data, texture data, environment information, and the like. Real-time spatial reproduction unit 407 generates a real-time three-dimensional model image on the basis of the transmission-side three-dimensional model information and the detection result of model motion detector 205 received in real time.

### [1-2. Operation]

Hereinafter, an operation of spatial reproduction system 1 configured as described above will be described.

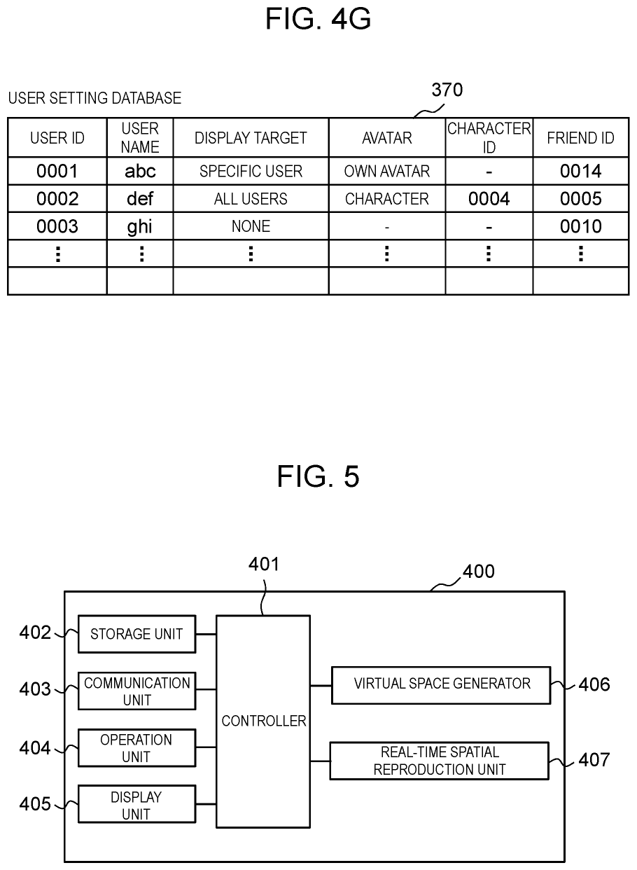

FIG. 6 is a sequence diagram showing an operation in each unit of spatial reproduction system 1 of FIG. 1. In FIG. 6, an operation of spatial reproduction system 1 includes control processing of one transmitting device 100, control processing of server device 200, and control processing of one receiving device 400. Descriptions of other transmitting devices 100 and other receiving devices 400 will be omitted as appropriate. Steps S100 to S500 are collectively referred to as preprocessing, and steps S600 to S800 are collectively referred to as real-time spatial reproduction processing.

In FIG. 6, in first data creation processing S100, transmitting device 100 creates spatial three-dimensional data and texture data for a space around sender 150. Additionally, transmitting device 100 also creates environment information regarding the space around sender 150. Thereafter, transmitting device 100 transmits the created spatial three-dimensional data, texture data, and environment information to server device 200.

In step S200, server device 200 registers the received various data in database memory 300. First data creation processing S100 may be repeated for each of multiple environments (set of date, time, and weather).

In second data creation processing S300, transmitting device 100 creates user three-dimensional data of sender 150, and sender 150 operates transmitting device 100 to make various settings in real-time spatial reproduction. Thereafter, transmitting device 100 transmits the created user three-dimensional data and setting information indicating setting values of various settings to server device 200.

In step S400, server device 200 registers the received various data in database memory 300.

In space generation processing S500, server device 200 transmits spatial three-dimensional data, texture data, user three-dimensional data, and setting information to receiving device 400, and receiving device 400 creates a three-dimensional virtual space on the basis of various received information. Additionally, receiving device 400 receives three-dimensional data and setting information of an avatar of sender 150 from server device 200, and changes various settings according to the setting information. The above-described preprocessing can be performed in advance, such as when the program is installed in receiving device 400, for example. In this case, server device 200 and receiving device 400 store various data created or registered in the preprocessing in storage units 204, 402.

After performing the preprocessing, real-time spatial reproduction processing is started. First, in third data creation processing S600, transmitting device 100 acquires user position information of sender 150 in the space using position information acquisition unit 106, and transmits the user position information to server device 200.

Server device 200 performs data acquisition processing S700 described later, and acquires environment information on the basis of the received user position information. Additionally, server device 200 receives captured image data from imaging device 600 that is capturing an image of sender 150, and acquires skeletal information of sender 150 from the captured image data. The received user position information and the acquired environment information and skeletal information are transmitted to receiving device 400.

In spatial reproduction processing S800, receiving device 400 combines the three-dimensional virtual space created in space generation processing S500, the three-dimensional model data of sender 150 received in space generation processing S500, and the environment information, skeletal information, and the like transmitted from server device 200 in real time, generates reproduction image 450 that reproduces sender 150 and the space around sender 150 in real time, and causes display unit 405 to display reproduction image 450.

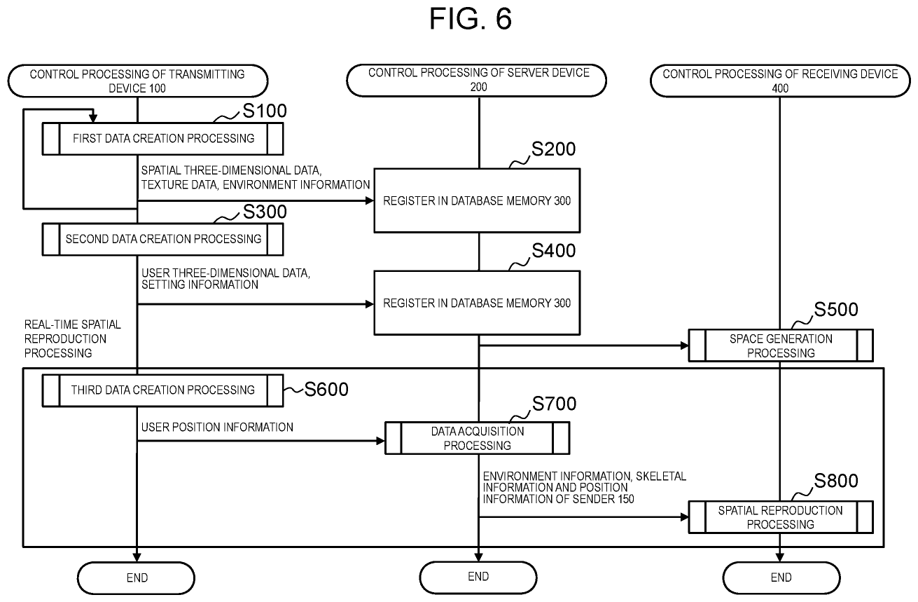

Hereinafter, an operation of each unit in each step will be described in detail with reference to FIGS. 7 to 12.

FIG. 7 is a flowchart showing a detailed operation example of first data creation processing S100. In FIG. 7, the first data creation processing includes steps S101 and S102. First, in step S101, transmitting device 100 acquires spatial three-dimensional data, texture data, and environment information. Spatial three-dimensional data is three-dimensional data of a shape of a target area, such as a building or terrain in a theme park, for example, and is expressed in the form of polygon vertices or the like. Spatial three-dimensional data is created in advance by an automobile with a 3D scan camera or from a design drawing of a facility such as a theme park, for example, and is stored in storage unit 102 or the like. Additionally, texture data to be attached to a three-dimensional model of spatial three-dimensional data is created in a similar manner. Spatial three-dimensional data and texture data may be acquired simultaneously or separately.

Moreover, environment information is recorded at the same time when texture data is acquired. Environment information is information including date, time, and weather. Information regarding weather is acquired by accessing an external weather server on the basis of position information acquired by a GPS receiver or the like, or is manually recorded.

In step S102, transmitting device 100 transmits the acquired various data to server device 200 through communication unit 103. Server device 200 registers the received data in database memory 300 (S200).

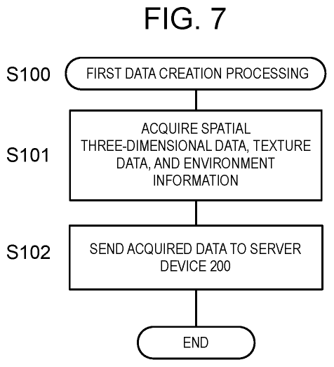

FIG. 8 is a flowchart showing a detailed operation example of second data creation processing S300 of FIG. 6. In FIG. 8, the second data creation processing includes steps S301 to S308. In step S301 of second data creation processing S300, user setting data to be registered in user setting database 370 shown in FIG. 4G is created.

In FIG. 8, first, in step S301, transmitting device 100 registers the user ID and user name of sender 150 by input from UI unit 107, for example. Next, in step S302, a GPS device carried by sender 150 is registered in and linked to transmitting device 100. Transmitting device 100 may register position information acquisition unit 106 of transmitting device 100 itself as a GPS device.

After step S302, second data creation processing S300 proceeds to step S307. In step S307, transmitting device 100 requests sender 150 to set the setting value of “display target”, and determines whether or not the setting value is “none”. If the value of “display target” is “none” (YES in step S307), second data creation processing S300 proceeds to step S305, and if the value is other than “none” (NO in step S307), the processing proceeds to step S308.

In step S308, transmitting device 100 requests sender 150 to set the setting value of “avatar”. The setting value of “avatar” is a setting value indicating how sender 150 is displayed in reproduction image 450 of receiving device 400, and is either “own avatar” or “character”. If the setting value is “own avatar” (YES in step S308), second data creation processing S300 proceeds to step S303, and if the setting value is “character” (NO in step S308), second data creation processing S300 proceeds to step S304.

In step S303, a three-dimensional model created by a 3D scanning system that images and reproduces sender 150 from various angles, for example, is set as a three-dimensional model of the avatar of sender 150. On the other hand, in step S304, three-dimensional models created and rendered in advance are presented to sender 150 through UI unit 107 or the like, and sender 150 is requested to select one. A three-dimensional model corresponding to the selected character is set as the three-dimensional model of the avatar of sender 150.

In step S305, friend setting is performed. That is, sender 150 is requested to input a user ID through UI unit 107 or the like, and the input user ID is set as the value of “friend ID”. In step S306, the user three-dimensional data and information of various setting values set in steps S301 to S305 described above are transmitted to server device 200. The user three-dimensional data includes model data and texture data of the three-dimensional model of the avatar of sender 150 set in step S303 or S304. Server device 200 registers the received data in user model database 350 and user setting database 370 as needed (S400).

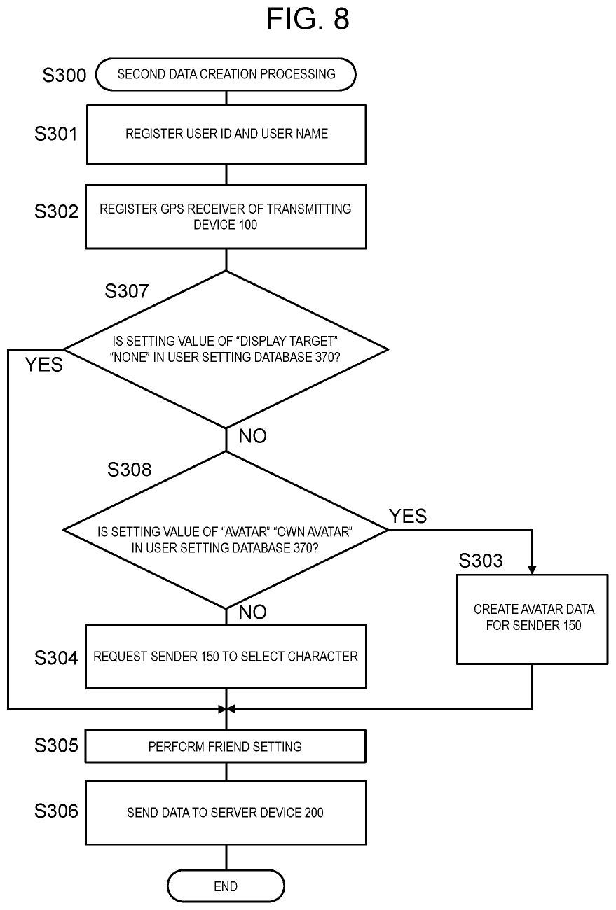

FIG. 9 is a flowchart showing a detailed operation example of space generation processing S500 of FIG. 6. Space generation processing S500 includes steps S501 to S505. In step S501, receiving device 400 requests receiver 440 to input his/her user ID. In step S502, receiving device 400 searches user setting database 370 for users whose “friend ID” value matches the input user ID value, and retrieves the user IDs, user names, and the like of the corresponding users to display them in a list on display unit 405. Receiver 440 determines sender 150 who reproduces the surrounding space by selecting one of the user IDs displayed in a list through operation unit 404.

In FIG. 9, in step S503, receiving device 400 receives the contents of environment information table 310, spatial environment correspondence table 320, and spatial texture database 330 from database memory 300 of server device 200, and stores the contents in storage unit 402. In step S504, receiving device 400 requests receiver 440 to select a viewpoint position. For example, the viewpoint position is selected from among a position of imaging device 600, a viewpoint position of sender 150, the side or rear of sender 150, a viewpoint position following the movement of receiver 440, and the like. A viewpoint position also includes the line-of-sight direction. Finally, in step S505, a three-dimensional virtual space is created using the various data received in step S503, and the viewpoint position is set.

When the above preprocessing is completed, the operation of spatial reproduction system 1 proceeds to the real-time spatial reproduction processing including control processing S600 to S800.

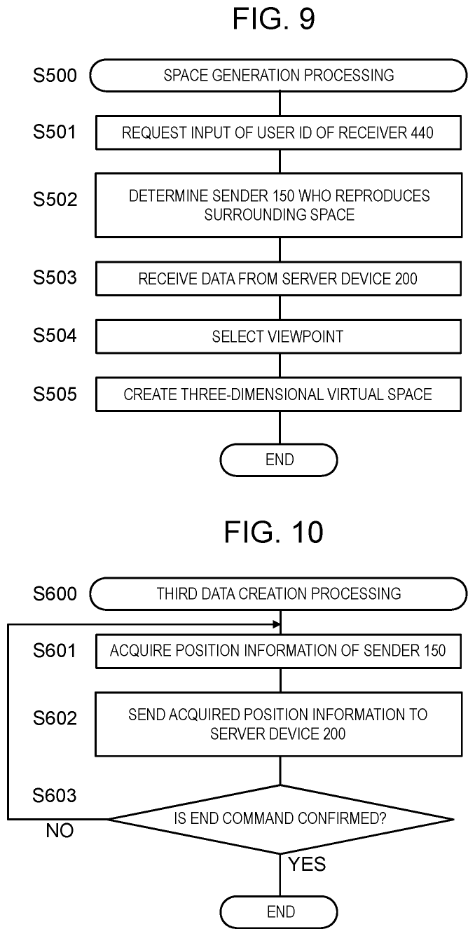

FIG. 10 is a flowchart showing a detailed operation example of third data creation processing S600 of FIG. 6. In FIG. 10, in step S601, transmitting device 100 acquires position information (latitude and longitude) of sender 150 from a GPS device or the like associated with transmitting device 100. In step S602, transmitting device 100 transmits the acquired position information to server device 200. Thereafter, in step S603, it is determined whether or not an end command is input by sender 150, and if the end command is input (YES in step S603), the processing is ended, and if the end command is not input (NO in step S603), the processing returns to step S601 to repeat third data creation processing S600.

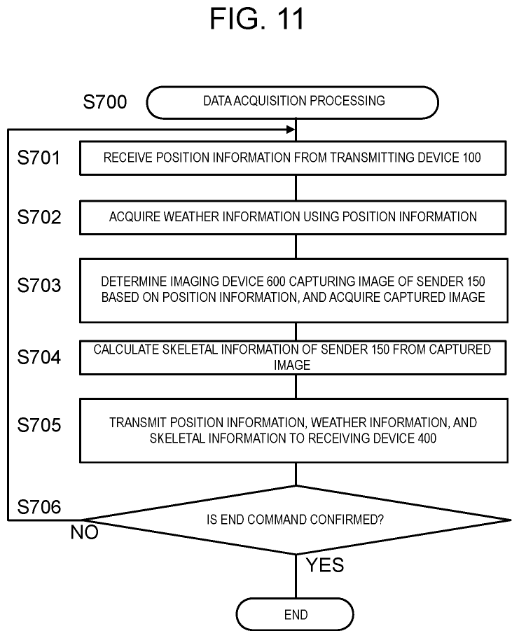

FIG. 11 is a flowchart showing a detailed operation example of data acquisition processing S700 of FIG. 6. Data acquisition processing S700 includes steps S701 to S706. First, in step S701, server device 200 receives the position information transmitted from transmitting device 100 in step S602 of FIG. 10. In step S702, the current weather is acquired by accessing an external weather server using the position information.

Additionally, in step S703, based on the position information and the contents of imaging device information table 340, imaging device 600 whose imaging area includes sender 150 is determined, and captured image data is received from this imaging device 600. Note that when an image of sender 150 is captured in multiple imaging devices 600, one imaging device 600 can be selected from multiple imaging devices 600 by selecting imaging device 600 in which sender 150 is closest to the center of the imaging area, or imaging device 600 closest to sender 150 (i.e., imaging device 600 that captures the largest image of sender 150).

In subsequent step S704, based on the acquired captured image data and position information, it is determined which of the multiple persons in the captured image is sender 150, and skeletal information of sender 150 determined above is calculated.

Thereafter, in step S705, the position information of sender 150 received in step S701, the weather information acquired in step S702, and the skeletal information calculated in step S704 are transmitted to receiving device 400. In step S706, it is determined whether or not an end command from a server administrator is confirmed, and if the end command is input (YES in step S706), the processing is ended, and if the end command is not input (NO in step S706), the processing returns to step S701 to repeat data acquisition processing S700.

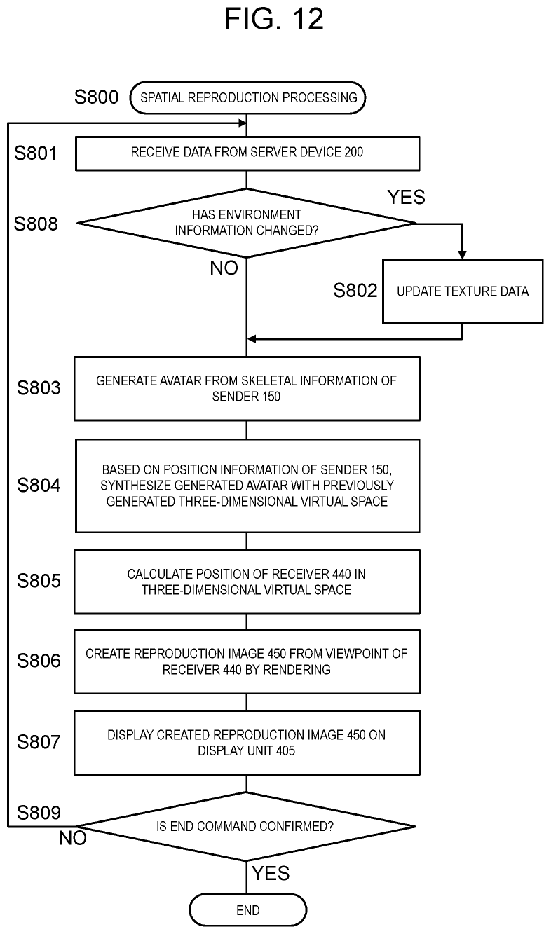

FIG. 12 is a flowchart showing a detailed operation example of spatial reproduction processing S800 of FIG. 6. In FIG. 12, spatial reproduction processing S800 includes steps S801 to S809. First, in step S801, receiving device 400 receives various data transmitted from server device 200 in step S705 of FIG. 11. After step S801, spatial reproduction processing S800 proceeds to step S808. In step S808, it is determined whether or not environment information has changed from the environment information at the time of the immediately preceding spatial reproduction processing. If the environment information has not changed (NO in step S808), spatial reproduction processing S800 proceeds to step S803. If the environment information has changed (YES in step S808), spatial reproduction processing S800 proceeds to step S802, texture data corresponding to the newly received environment information is read from texture data set 332 stored in storage unit 402 to update the texture data used for space reproduction, and then the processing proceeds to step S803.

In step S803, a three-dimensional model of an avatar stored in storage unit 402 is generated on the basis of the received skeletal information of sender 150. In step S804, the generated avatar is synthesized with a three-dimensional virtual space on the basis of the position information of sender 150. In step S805, a viewpoint position of receiver 440 in the three-dimensional virtual space is calculated. The viewpoint position is a viewpoint position shifted from the viewpoint position of sender 150 by a predetermined distance according to the setting value of the viewpoint selected in step S504, or a viewpoint position in the three-dimensional virtual space corresponding to a viewpoint position in the physical space of receiver 440 acquired by a camera (not shown) or the like that captures an image of receiver 440, for example.

Subsequently, in step S806, based on the three-dimensional virtual space with which the avatar of the sender 150 is synthesized and the viewpoint position in the three-dimensional virtual space of receiver 440, reproduction image 450, which is an image of the three-dimensional virtual space as seen from the viewpoint position of receiver 440, is created by rendering. Finally, in step S807, created reproduction image 450 is displayed on display unit 405 and shown to receiver 440.

In step S809, it is determined whether or not an end command is input by receiver 440, and if the end command is input (YES in step S809), the processing ends, and if the end command is not input (NO in step S809), the processing returns to step S801 to repeat spatial reproduction processing S800.

### [1-3. Effects and Others]

As described above, the spatial reproduction method of spatial reproduction system 1 according to the first exemplary embodiment includes processing (S100 to S400) of transmitting various data including spatial information (spatial three-dimensional data and texture data) from transmitting device 100 to receiving device 400 through server device 200, processing (S500) of creating a three-dimensional virtual space on the basis of the spatial information received by receiving device 400, and processing (S600 to S800) of transmitting various data including motion information (skeletal information) of sender 150 in real time from transmitting device 100 to receiving device 400 through server device 200. In real-time processing, data communicated through the network is position information of sender 150, environment information, skeletal information, and captured image data from imaging device 600. The position information, environment information, and skeletal information can be communicated by simple text information. Additionally, the captured image data to be communicated is limited to that from only one imaging device 600. Accordingly, the communication load of each device and the network is smaller than the communication load in the conventional technique in which a large amount of high-quality images are simultaneously communicated.

Additionally, if an image of sender 150 is captured even in a single one of multiple imaging devices 600 installed in the target area, the surrounding space can be reproduced. Hence, a wider target area than in the conventional technique can be reproduced with less imaging devices than in the conventional technique. The reduction in the number of imaging devices 600 reduces the communication load between imaging devices 600 and server device 200 as compared with the conventional technique.

### Other Exemplary Embodiments

Note that as shown in FIG. 1, in addition to sender 150, other sender 150 may be present in the imaging area of imaging device 600. In such a case, steps S803, S804 are repeated for other sender 150, too, if the value of “display target” of other sender 150 in user setting database 370 is “all users”, or is “specific user” and the user ID of receiver 440 is included in “friend ID” of other sender 150. Then, other sender 150 may be displayed in reproduction image 450. Note, however, that since the resources required for processing may increase due to an increase in the number of avatars to be synthesized, an upper limit value such as 10 may be set for the number of senders 150 to be displayed in reproduction image 450, for example. The upper limit value may be freely changed by receiver 440 in consideration of the performance or the like of controller 401.

Additionally, in steps S603, S706, S809, transmitting device 100, server device 200, and receiving device 400 end processing after determining whether or not an end command from the user of the device (e.g., sender 150, server administrator, receiver 440, or the like) is confirmed. At this time, if one of the devices confirms an end command from the user, the device may be configured to end processing after transmitting an end command to the other two devices. Additionally, when receiving device 400 ends spatial reproduction processing S800 by an end command from transmitting device 100, for example, the fact that the processing is ended may be notified by an operation of sender 150.

Moreover, in the first exemplary embodiment, display unit 405 displays both the user interface for selecting various settings and reproduction image 450. However, such as displaying the user interface on a display and displaying reproduction image 450 on a head-mounted display, receiving device 400 may include multiple display units 405 and display different information on each of display units 405.

Furthermore, when the real-time spatial reproduction processing is started, both sender 150 and receiver 440 may be notified, and services such as chat and voice call may be performed in parallel according to operations of sender 150 and receiver 440.

Additionally, in the first exemplary embodiment, human sender 150 is assumed as the object to be reproduced in the three-dimensional virtual space. However, any object may be used, as long as the motion information of the target object can be calculated from the captured image data captured by imaging device 600 and the receiving device can reproduce the target object on the basis of the motion information. For example, an automobile, an animal, or the like may be the object, or any combination thereof may be the object. When the object includes an automobile, server device 200 may calculate and transmit orientation information of the vehicle body and wheels of the automobile as motion information.

Further, in the first exemplary embodiment, server device 200 includes model motion detector 205, and calculates the skeletal information of sender 150 on the basis of the captured image data received from imaging device 600. However, transmitting device 100 may further include imaging device information table 340, model motion detector 205, and the like to calculate the skeletal information.

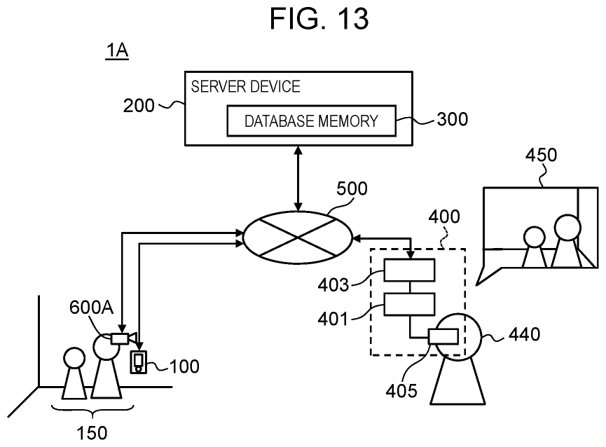

Furthermore, when sender 150 enters a blind spot of imaging device 600 and is not imaged by any of imaging devices 600, skeletal information may be automatically predicted on the basis of the position information, speed, and the like of sender 150. Additionally, image data from imaging device 600 may be any data as long as it can identify the skeletal information of sender 150. FIG. 13 is a block diagram showing a configuration example of spatial reproduction system 1A according to a modification. Hence, as shown in FIG. 13, for example, using imaging device 600A that is fixed to the head of sender 150 and is linked to the motion of sender 150, skeletal information of sender 150 may be estimated on the basis of captured image data from imaging device 600A.

The foregoing exemplary embodiments have been described as examples of the technique of the present disclosure. The accompanying drawings and the detailed description have been provided for this purpose.

For illustration of the above technique, the constituent elements illustrated and described in the accompanying drawings and the detailed description may include not only the constituent elements that are essential for solving the problem but also constituent elements that are not essential for solving the problem. These non-essential constituent elements therefore should not be instantly construed as being essential, based on the fact that the non-essential constituent elements are illustrated and described in the accompanying drawings and the detailed description.

Further, the foregoing exemplary embodiments are provided to exemplify the technique of the present disclosure, and thus various alterations, substitutions, additions, omissions, and the like can be made within the scope of the claims or equivalents of the claims.

The present disclosure is applicable to a real-time spatial reproduction system.

What is claimed is:

1. A spatial reproduction method for reproducing a space including an object, the method comprising:
creating, by a receiving device, a three-dimensional virtual space based on spatial information previously acquired by the receiving device;
transmitting motion information indicating a motion of the object to the receiving device in real time by a transmitting device communicably connected to the receiving device; and
synthesizing, by the receiving device, an avatar of the object with the three-dimensional virtual space based on the motion information.

2. The spatial reproduction method according to claim 1, further comprising
acquiring the spatial information in advance by receiving from a server device communicably connected to the receiving device.

3. The spatial reproduction method according to claim 1, further comprising:
receiving captured image data from at least one imaging device that includes the object in an imaging range or has an imaging range corresponding to a motion of the object; and
determining motion information of the object based on the captured image data.

4. The spatial reproduction method according to claim 1, further comprising acquiring position information of the object and determining motion information of the object based on the acquired position information.

5. The spatial reproduction method according to claim 1, wherein the spatial information includes spatial three-dimensional data and texture data.

6. The spatial reproduction method according to claim 1, wherein
the spatial information is any one of a plurality of spatial information pieces corresponding to a plurality of environment information pieces, and
the spatial reproduction method further comprises:
of the plurality of spatial information pieces, selecting one spatial information piece corresponding to the current environment information; and
creating the three-dimensional virtual space based on the selected spatial information piece.

7. The spatial reproduction method according to claim 6, wherein the environment information includes at least one of weather, a time or a time zone, and a date or a season.

8. The spatial reproduction method according to claim 1, wherein the object includes at least one of a human, an animal, and an automobile.

9. The spatial reproduction method according to claim 8, wherein the motion information includes at least one of skeletal information of the human, skeletal information of the animal, and azimuth information of the automobile.

10. A spatial reproduction method for reproducing a space including an object, the method comprising:
creating a three-dimensional virtual space based on previously acquired spatial information;
receiving captured image data from at least one imaging device that includes the object in an imaging range or has an imaging range corresponding to a motion of the object;
determining motion information of the object based on the captured image data;
transmitting the determined motion information in real time; and
synthesizing an avatar of the object with the three-dimensional virtual space based on the transmitted motion information.

11. A spatial reproduction system for reproducing a space including an object, the system comprising:
a receiving device configured to create a three-dimensional virtual space based on previously acquired spatial information; and
a transmitting device communicably connected to the receiving device and transmitting motion information of the object to the receiving device in real time, the receiving device synthesizing the object with the three-dimensional virtual space based on the received motion information.

12. The spatial reproduction system according to claim 11, wherein the motion information is determined based on captured image data captured by at least one imaging device that includes the object in an imaging range or has an range corresponding to a motion of the object.
